(19) United States
(12) Patent Application Publication
(10) Pub. No.: US 2014/0157294 A1
(43) Pub. Date: Jun. 5, 2014

(54) CONTENT PROVIDING APPARATUS, CONTENT PROVIDING METHOD, IMAGE DISPLAYING APPARATUS, AND COMPUTER-READABLE RECORDING MEDIUM

(71) Applicant: SAMSUNG ELECTRONICS CO., LTD., Suwon-si (KR)

(72) Inventors: Sung-moon CHUNG, Yongin-si (KR); Sung-soo KIM, Seoul (KR); Jong-lok KIM, Seoul (KR); Jong-il CHOI, Seoul (KR); Yun-sung HWANG, Seoul (KR)

(73) Assignee: SAMSUNG ELECTRONICS CO., LTD., Suwon-si (KR)

(21) Appl. No.: 14/097,690

(22) Filed: Dec. 5, 2013

(30) Foreign Application Priority Data
Dec. 5, 2012 (KR) 10-2012-0140565

(51) Int. Cl. H04N 21/442

(52) U.S. Cl. CPC H04N 21/44218
USPC 725/10

(57) ABSTRACT

A content providing apparatus, a content providing method, an image forming displaying apparatus, and a computer-readable recording medium are provided. A content providing apparatus includes a communication interface configured to receive viewer reaction information related to a program from an image displaying apparatus, a highlight information generator configured to measure a level of viewer reaction by analyzing the received viewer reaction information, and generates highlight information by detecting highlights based on the measured level of viewer reaction, wherein the generated highlight information is stored, and the image displaying apparatus is provided with the stored highlight information.

### CROSS-REFERENCE TO RELATED APPLICATION

This application claims priority from Korean Patent Application No. 10-2012-0140565, filed on Dec. 5, 2012, in the Korean Intellectual Property Office, the disclosure of which is incorporated herein by reference in its entirety.

### BACKGROUND

1. Field

Apparatuses and methods consistent with exemplary embodiments relate to a content providing apparatus, a content providing method, an image forming displaying apparatus, and a computer-readable recording medium, and more particularly, to a content providing apparatus capable of providing the highlights (or main scenes) of a program according to viewers (or users) based on viewing state information about the viewer obtained from an image displaying apparatus such as a television.

2. Description of the Related Art

Recently, as visual media such as televisions (TVs) and mobile phones have rapidly developed, the users have desired more advanced quality of services. Formerly the viewers watched a TV program transmitted from a broadcasting station unilaterally, whereas these days the viewers can freely watch any TV program any time they want due to bilateral communications by the propagation of internet TVs.

However, highlights of sporting events have still been provided in accordance with analysis of some experts or standards of broadcasting media. Accordingly, it may not meet the viewers' requirements. In other words, highlights of sporting events usually reflect the opinion of a minority of experts. The highlights set by the opinion of a minority of experts may be different from highlights determined by the viewers. This has resulted in the viewer's dissatisfaction regarding a particular service.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

An aspect of an exemplary embodiment provides a content providing apparatus capable of providing highlights of a program according to viewers based on viewer information obtained from an image displaying apparatus such as a television, a content providing method thereof, an image displaying apparatus, and a computer-readable recording medium.

According to an aspect of an exemplary embodiment, a first apparatus comprising a communication interface configured to receive viewer reaction information related to a program from second apparatus, a highlight information generator configured to measure a level of viewer reaction by analyzing the received viewer reaction information, and generates highlight information by detecting highlights based on the measured level of viewer reaction, wherein the generated highlight information is stored, and the second apparatus is provided with the stored highlight information.

The highlight information generator may generate list information related to the highlights according to the level of viewer reaction, and the storage may provide the second apparatus with the highlight information of the highlights which the viewer selects from among the list information provided, when the viewer requests.

The highlight information generator may measure the level of viewer reaction by analyzing at least one from among a number of viewers who view the program, viewers' voices, viewer's facial expressions, and viewer's motions, using the viewer reaction information.

The highlight information generator may determine that the level of viewer reaction is higher when at least one from among the number of viewers is large, and the viewers' voices, facial expressions, or motions are larger.

The highlight information generator may measure the level according to a group related to at least one from among viewers' gender, district, age, and tendency, by analyzing the viewer reaction information, and detect the highlights based on the measured level of viewer reaction according to the group.

The first apparatus may further comprise a storage. The storage may store data regarding the highlights according to an analyzed group and updates the stored data.

The storage may store image information related to the program, and the highlight information generator may generate the highlight information using the stored image information and the viewer reaction information.

The highlight information generator may generate the highlight information by detecting highlights related to a level of viewer reaction which is higher than a preset threshold value.

According to another aspect of an exemplary embodiment, a content providing method includes receiving viewer reaction information related to a program from an apparatus, measuring level of viewer reaction by analyzing the received viewer reaction information, generating highlight information by detecting highlights based on the measured level of viewer reaction, and storing the generated highlight information, and providing the apparatus with the stored highlight information.

The content providing method may further include generating list information related to the highlights according to the level, and providing the list information when the viewer requests the highlights related to the program, and providing the highlight information related to the highlights which the viewer selects from among the list information.

In the measuring of the level, the level may be measured by analyzing at least one from among a number of viewers who view the program, and viewers' voices, facial expressions, and motions, using the viewer reaction information.

In the measuring of the level, the level may be set higher when the number of viewers is larger or when the viewers' voices, facial expressions, or motions are large.

In the measuring of the level, the level is measured according to a group related to at least one from among viewers' gender, district, age, and tendency, by analyzing the viewer reaction information, and in the generating of the highlight information, the highlight information related to the highlights may be generated based on the measured level according to the group.

In the storing of the generated highlight information, the highlight information related to the highlights may be stored according to an analyzed group and the stored information may be updated.

In the storing of the generated highlight information, image information related to the program may be stored, and in the generating of the highlight information, the highlight information may be generated using the stored image information and the viewer reaction information.

In the generating of the highlight information, the highlight information may be generated by detecting highlights related to a level of viewer reaction which is higher than a preset threshold value.

According to yet another aspect of an exemplary embodiment, an image displaying apparatus includes a display unit which displays an image related to a program, a viewer reaction information acquirer configured to acquire viewer reaction information related to the program and provides a second apparatus with the viewer reaction information, and a user information inputter configured to request highlight information related to highlights of the program, which is generated based on the viewer reaction information and image information related to the program, highlights of the program, wherein the display unit additionally displays the highlight information provided the content providing apparatus.

The viewer reaction information acquirer may include a photographing unit which outputs an image obtained by photographing a viewer as the viewer reaction information, and a voice recognizer configured to acquires and outputs the viewer's voice as the viewer reaction information.

The first apparatus may further include a graphical user interface (GUI) generator configured to generate list information about the highlights, wherein the display unit displays the generated list information in an interface window form and displays the highlight information which is selected from among the list information.

According to yet another aspect of an exemplary embodiment, a computer-readable recording medium stores a program to execute a content providing method, the method including receiving viewer reaction information related to a program from an apparatus, measuring level of viewer reaction by analyzing the received viewer reaction information, generating highlight information by detecting highlights based on the measured level of viewer reaction, and storing the generated highlight information, and providing the image displaying apparatus with the stored highlight information.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the exemplary embodiments will be more apparent with reference to the accompanying drawings, in which:

FIG. 1 is a block diagram illustrating a content providing system according to an exemplary embodiment;

FIG. 2 is a block diagram illustrating a configuration of the image displaying apparatus shown in FIG. 1;

FIG. 3 is a block diagram illustrating a configuration of the content providing apparatus shown in FIG. 1;

FIG. 4 illustrates a content providing process according to an exemplary embodiment;

FIG. 5 illustrates a content providing process according to another exemplary embodiment; and

FIG. 6 is a flow chart illustrating a content providing method according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments can be carried out without those specifically defined matters. Also, well-known functions or constructions are not described in detail since they would obscure the description of the exemplary embodiments with unnecessary detail.

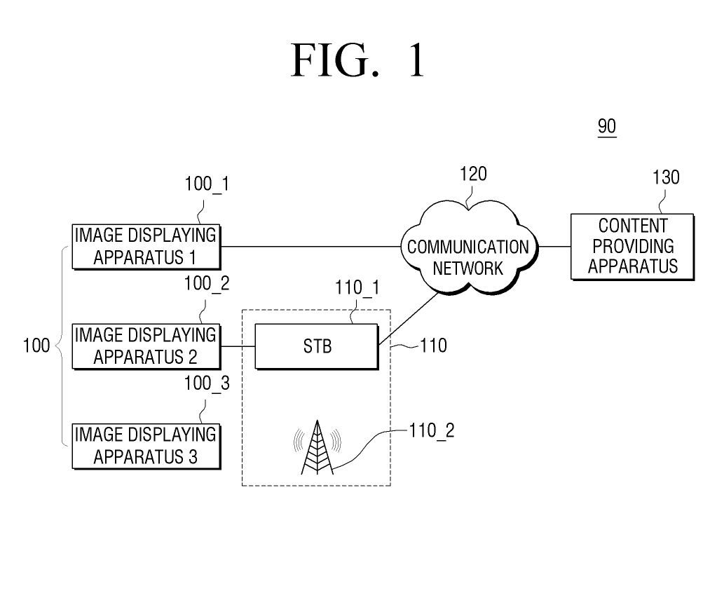

FIG. 1 is a block diagram illustrating a content providing system according to an exemplary embodiment.

As shown in FIG. 1, the content providing system 90 may include an image displaying apparatus 100, a relay apparatus 110, a communication network 120, and a content providing apparatus 130 in whole or in part.

Herein, including them in whole or in part indicates that it may be possible to omit a part of them such as the relay apparatus 110. For sufficient understanding of description, it is assumed that all the components are included.

The image displaying apparatus 100 may include at least one of an image displaying apparatus 1 (100_1) to an image displaying apparatus 3 (100_3). For example, the image displaying apparatus 100 may include televisions (TVs), mobile phones, navigators, notebook computers, and personal digital assistants (PDAs). In the exemplary embodiment, the image displaying apparatus 1 (100_1) and image displaying apparatus 2 (100_2) may be TVs, and the image displaying apparatus 3 (100_3) may be a mobile terminal such as a mobile phone, navigator, and notebook computer.

The image displaying apparatus 100 according to the exemplary embodiment may include a viewer reaction information acquisition unit (not shown) which acquires state information regarding the viewer (or viewer reaction information) who watches a broadcast program (or content image). The viewer reaction information acquisition unit may include a photographing unit which may include a camera, and a voice recognition unit. The image displaying apparatus 100 may photograph the viewer's eyes, mouth, movement, facial expression, etc. and provide the content providing apparatus 130 with that acquired data. For example, when photographing the viewer's mouth movements, the image displaying apparatus 100 may acquire the size and content of the viewer's voice as well and provide the content providing apparatus 130 with that acquired data.

For example, let's suppose the image displaying apparatus 100 is a standard household TV. In this case, the image displaying apparatus 100 may acquire an image by photographing family members who are viewing a program, acquire their voices as well, and provide the content providing apparatus 130 with the image and voices. At this time, the image displaying apparatus 100 may additionally provide device identification (ID) and MAC address information together.

In addition, if the viewer requests highlights of a program in which he is interested, the image displaying apparatus 100 may display list information about the highlights provided by the content providing apparatus 130 on an interface window. Of course, the image displaying apparatus 100 may receive data regarding highlights selected from the list information. Furthermore, the image displaying apparatus 100 may include a graphical user interface (GUI) generation unit to implement the interface window. The GUI generation unit may store and execute software to display the list information in the interface window form.

For example, if the viewer requests highlights regarding sports programs, the image displaying apparatus 100 may transmit the request to the content providing apparatus 130 directly via the communication network 120 or via the relay apparatus 110 and communication network 120 and receive list information about various sporting events. At this time, if the viewer requests highlights of a baseball program in the list information, the content providing apparatus 130 may provide the viewer with data of highlights which were edited and stored when the viewer was viewing the program.

The relay apparatus 110 may include a set-top box (STB) 110_1 and an access point (AP) 110_2. The STB110_1 and AP 110_2 interwork with the image displaying apparatus 2 (100_2) and image displaying apparatus 3 (100_3) respectively so as to process signals. In other words, if the viewer requests highlights of a program in which he is interested through the image displaying apparatus 2 (100_2) or image displaying apparatus 3 (100_3), the STB110_1 or AP 1102 may transmit the request to the content providing apparatus 130 via the communication network 120. In addition, if list information about highlights is provided from the content providing apparatus 130, the STB110_1 or AP 110_2 may transmit selection information that the viewer selects from among the list information to the content providing apparatus 130. Furthermore, the relay apparatus 110 may receive data regarding the highlights from the content providing apparatus 130 and transmit the data to the image displaying apparatus 2 (100_2) or image displaying apparatus 3 (100_3).

The communication network 120 may include wired and wireless communication networks, local area network (LAN), etc. The wired communication network includes internet network such as a cable network and Public Switched Telephone Network (PSTN). The wireless communication network includes code division multiple access (CDMA), wideband code division multiple access (WCDMA), global system for mobile communication (GSM), Evolved Packet Core (EPC), long term evolution (LTE), Wireless Broadband Internet (WiBro) network, etc. Accordingly, if the communication network 120 is wired communication network, the AP 1102 may access a telephone exchange office, or if the communication network 120 is wireless communication network, the AP 1102 may access Serving GPRS Support Node (SGSN) or Gateway GPRS Support Node (GGSN) operated by a telecommunications company and an exchange device or access diverse relay apparatuses such as base station transmission (BST), NodeB, e-NodeB, etc. so that image data can be processed.

The content providing apparatus 130 may be a server of a broadcasting station and provide image data of highlights of a program that the viewer requests. Prior to providing the image data, when the viewer requests highlights, the content providing apparatus 130 may provide list information about various programs and provide highlights of a program which is selected from among the list information. Or, in terms of a single program, the content providing apparatus 130 may provide list information about highlights classified according to importance (or level) and provide highlights of a particular importance. If the broadcasting station has already figured out a viewing state according to viewers, the broadcasting station may provide highlights of sports differently according to viewers based on the viewing state without a separate request of the viewer when broadcasting a regular broadcast, for example, news.

In order to build data regarding highlights as described above, the content providing apparatus 130 may store data by classifying level (importance) of highlights based on images obtained by photographing the viewer or the viewers' voice size and spoken content when the viewer is viewing a program through the image displaying apparatus 100. At this time, the content providing apparatus 130 may filter and store data of highlights having importance (level) which is greater than a preset value. For example, the content providing apparatus 130 may determine the importance of highlights based on the number of viewers or concentration level of viewers. In addition, the content providing apparatus 130 may determine the importance of highlights by analyzing the viewers' mouth movements, voice size, and spoken content. Furthermore, the content providing apparatus 130 may determine the importance of highlights by analyzing a phased emotional state based on the viewers' motion size (e.g., the amount of motion of a viewer), posture, and facial expression. During this process, the content providing apparatus 130 may figure out the viewers' gender, age, district, etc. as well, classify them into groups, and store this data according to group, thereby selecting and providing optimal highlights suitable for the viewers. For example, the viewer's intonation is figured out from his spoken content so that it may be shown that the viewer lives in Seoul but is interested in a sports team of the Gyeongsang-do district. In this case, highlights are stored by grouping the viewer into the corresponding district.

More specifically, let's suppose that a viewer is viewing a broadcast of a baseball game and requests editing of highlights through the image displaying apparatus 100. If the request is received, the content providing apparatus 130 determines the request time and what program the viewer is viewing based on a stored broadcasting time table. For example, the image displaying apparatus 100 may generate a message to provide information about the device and channel so that the content providing apparatus 130 may know what program of the channel the viewer is viewing. Subsequently, the content providing apparatus 130 receives the photographed image and voice information of the viewer from the image displaying apparatus 100 and edits and stores highlights of the program according to a particular time based on the received photographed image and voice information.

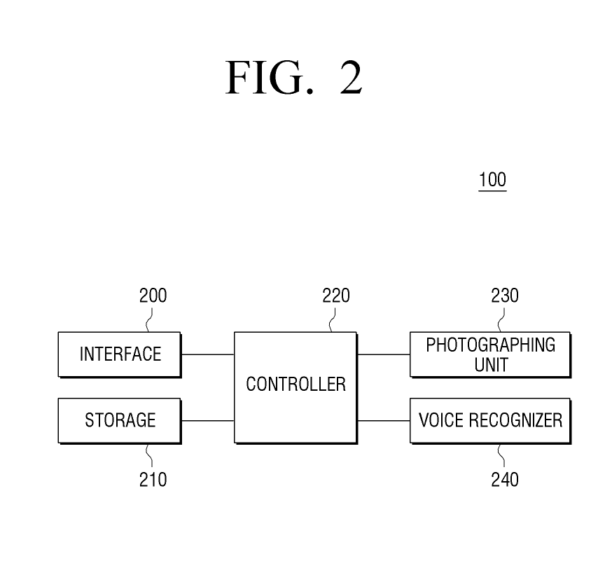

FIG. 2 is a block diagram illustrating a configuration of the image displaying apparatus 100 shown in FIG. 1.

As shown in FIG. 2, the image displaying apparatus 100 may include an interface unit (or an interface) 200, a storage unit (or a storage) 210, a control unit (or a controller) 220, a photographing unit 230, a voice recognition unit (or a voice recognizer) 240, and a GUI generation unit (or a GUI generator) (not shown) in whole or in part. Herein, including them in whole or in part indicates that it may be possible to omit one of them, for example, the photographing unit 230 or voice recognition unit 240. For sufficient understanding of description, it is assumed that all the components are included.

The interface unit 200 may include a communication interface unit and a user interface unit. The communication interface unit transmits the content providing apparatus 130 an image and voice which are acquired by a viewer reaction information acquisition unit. At this time, the communication interface unit may encode the image and voice. The user interface unit may include a user information input unit which includes a button to enable the viewer to input information for request for highlights, and a display unit which displays the highlights. If the display unit is a touch panel, the viewer may input user information by touch.

The storage unit 210 stores an input program image and outputs the program image to the display unit under control of the control unit 220. In addition, the storage unit 210 may store an image photographed by the photographing unit 230 and voice information of the voice recognition unit 240 and output the stored one to the content providing apparatus 130.

The control unit 220 controls overall operations of the interface unit 200, storage unit 210, photographing unit 230 and voice recognition unit 240 in the image displaying apparatus 100. The control unit 220 may display a program image stored in the storage unit 210 on the display unit and provide the content providing apparatus 130 with a photographed image and voice information.

The photographing unit 230 may include a camera and photograph a viewing state (reaction) of the viewer when the viewer is viewing an image displayed on the display unit. The voice recognition unit 240 acquires the viewer's voice.

The GUI generation unit (not shown) may store and execute software to activate the display unit and display list information about highlights of a particular program which is received from the content providing apparatus 130, in an interface window. Alternatively, the GUI generation unit may generate a corresponding interface window.

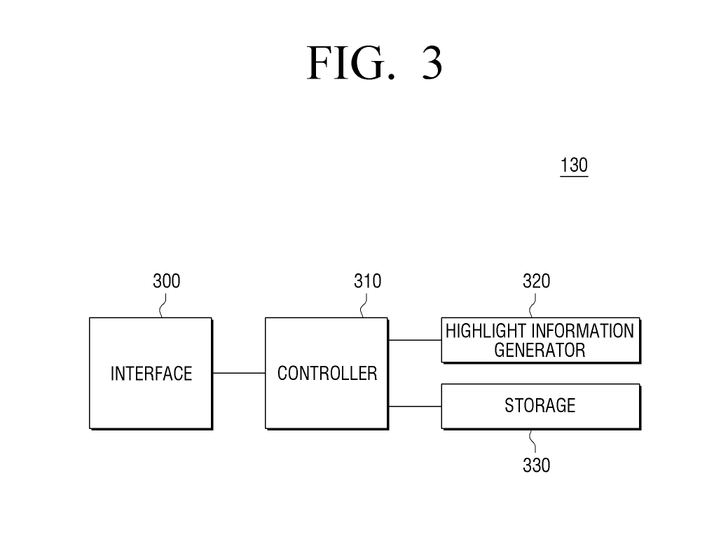

FIG. 3 is a block diagram illustrating a configuration of the content providing apparatus 130 shown in FIG. 1.

With reference to FIGS. 1 and 3, the content providing apparatus 130 may include an interface unit 300, a control unit 310, a highlight information generating unit 320, and a storage unit 330 in whole or in part.

Herein, including them in whole or in part indicates that it may be possible to omit a part of them or combine a part of them. For example, the highlight information generating unit 320 may include functions of the control unit 310 and storage unit 330. For sufficient understanding of the invention, it is assumed that all the components are included.

The interface unit 300 may be a communication interface unit according to an exemplary embodiment, but the exemplary embodiment is not limited thereto. The interface unit 300 may further include a user interface unit such as a user information input unit to enable the viewer to input information and a display unit to display data on screen for monitoring. The interface unit 300 receives viewing state information about the viewers which is acquired by the image displaying apparatus 100. The viewing state information may have been encoded by the image displaying apparatus 100. Accordingly, the interface unit 300 may decode the viewing state information and provide the control unit 310 with the decoded information.

The control unit 310 controls overall operations of the interface unit 300, highlight information generating unit 320, and storage unit 330. For example, the control unit 310 may provide the highlight information generating unit 320 with viewing state information about viewers which is received by the interface unit 300. In addition, when the viewer requests highlights, the control unit 310 may determine whether there is a request and provide the image displaying apparatus 100 with list information about highlights stored in the storage unit 330 or provide data regarding highlights which the viewer selects from among the list information. Furthermore, the control unit 310 may store in the storage unit 330 image data regarding highlights which are edited by the highlight information generating unit 320 and are classified according to time and importance.

The highlight information generating unit 320 measures level (e.g. importance) of highlights according to time by analyzing received viewing state information, edits highlights according to the measured level, and stores the edited data. In other words, the highlight information generating unit 320 may determine importance of highlights based on the number of viewers, the viewers' mouth movements, voice size, and spoken content in the viewing state information. In addition, the highlight information generating unit 320 may determine importance of highlights using the viewers' concentration level by tracking the viewers' eyes or using the viewers' phased emotional state based on the viewer's posture, motion size, and facial expression. In the exemplary embodiment, level of highlights may be determined by analyzing at least one of such diverse situations. During this process, the highlight information generating unit 320 may only store highlights of a level which is higher than a preset threshold value. Accordingly, the exemplary embodiment is not limited to a method to store data.

In addition, when storing data regarding highlights classified according to level, the highlight information generating unit 320 may store the data according to group. In other words, the highlight information generating unit 320 obtains information classified according group of the viewers from the received viewing state information and stores highlights classified according to time and group based on the level. For example, information may be grouped according to the viewers' gender, age, district, and tendency. Accordingly, the highlight information generating unit 320 may classify and store highlights according to group based on level, and provide the viewers with data regarding highlights.

The storage unit 330 may store information about a program time table according to a broadcasting station, and store data regarding highlights according to the level (importance) of the highlights as determined by the viewers classified according to group, i.e. gender and age. The information about the program time table is information needed to discriminate channel information and a broadcast program of a particular time from a message transmitted when the viewer requests highlights of the program. Accordingly, in the exemplary embodiment, data regarding highlights of the program may be stored using the information about the program time table. Subsequently, if the viewer requests data regarding highlights, the storage unit 330 may output the stored data under control of the control unit 310.

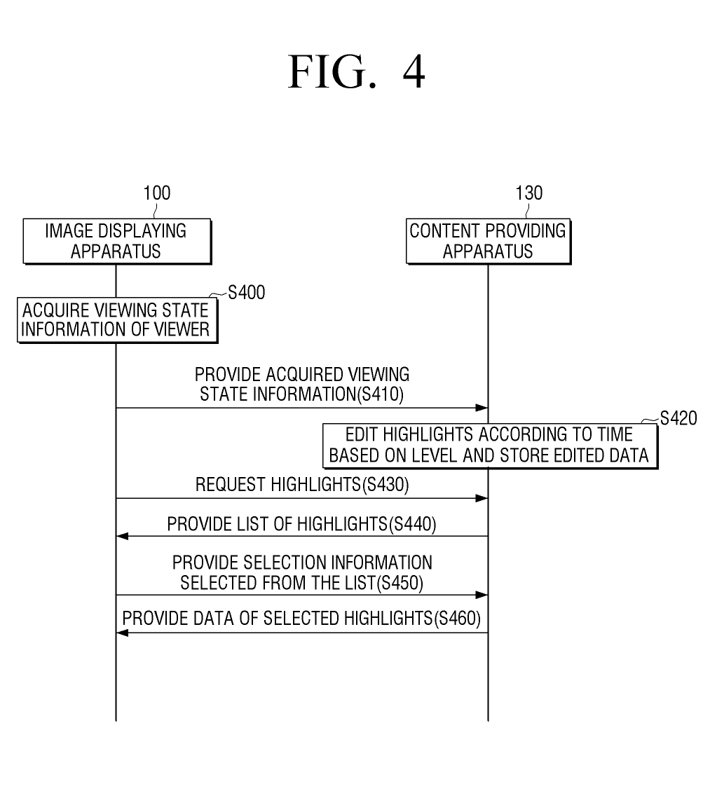

FIG. 4 illustrates a content providing process according to an exemplary embodiment.

With reference to FIG. 4, in operation S400, the image displaying apparatus 100 may acquire viewing state information of a viewer who is watching a program, for example, in accordance with the viewer's request. For example, let's suppose that while using a remote controller, the viewer indicated the possibility of subsequently requesting highlights of a program which the viewer is currently viewing. If there is such a request, the image displaying apparatus 100 starts acquiring viewing state information of the viewer. The viewing state information is information about a photographed image and voice input through a microphone, which includes the number of viewers, the viewers' eye movements, voice recognition information such as mouth movements, voice size, and spoken content, the viewers' motion size, posture, and facial expression showing a phased emotional state, and the viewers' group information such as gender, age, and district.

Subsequently, the content providing apparatus 130 receives the viewing state information from the image displaying apparatus 100 in operation S410, and analyzes the viewing state information, edits highlights according to a level of the program based on the analysis results, and stores the edited highlights in operation S420. In other words, the content providing apparatus 130 analyzes the viewing state information, i.e. the photographed image and input voice, determines level, e.g. importance, of highlights according to time of the program, and stores image data edited according to the importance.

After finishing viewing of the program, if the viewer requests highlights of a particular program through the image displaying apparatus 100 at a particular time in operation S430, the content providing apparatus 130 provides list information regarding highlights classified according to time for a plurality of programs, by extension, the particular program in operation S440. In this case, the image displaying apparatus 100 may activate and display an interface window showing the list information.

In addition, if the viewer selects the highlights of the particular program from among the list information in operation S450, the content providing apparatus 130 provides data regarding the selected highlights in operation S460.

Until now, it has been described with reference to FIG. 3 that the content providing apparatus 130 provides the image displaying apparatus 100 with the list information. However, the exemplary embodiments are not limited thereto. For example, a server of a broadcasting station periodically may monitor viewing state information about viewers, store data for highlights according to viewers, and provide highlights according to a viewer as sports highlights when broadcasting a regular program, for example, news. In other words, the broadcasting station provides different sports highlights according to viewers when broadcasting news.

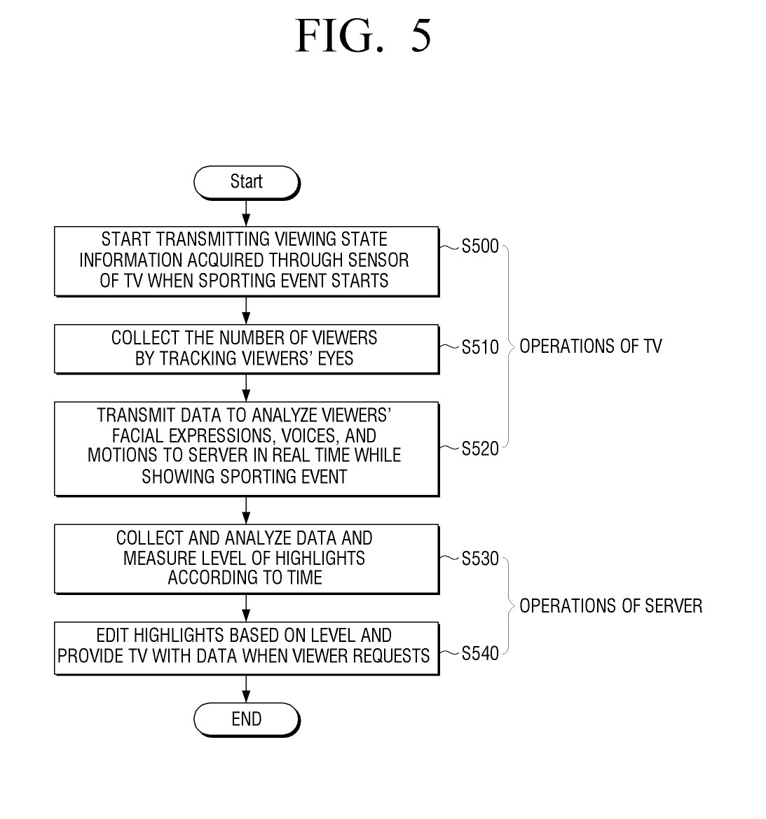

FIG. 5 illustrates a content providing process according to another exemplary embodiment. For convenience of description, let's suppose that the image displaying apparatus 100 shown in FIG. 4 is a TV, the content providing apparatus 130 is a server, and the TV is broadcasting sports content (or a sporting event).

With reference to FIGS. 1 and 5, in operation S500, when the sporting event starts, the TV may start acquiring viewing state information about a viewer who is viewing the sporting event through a charge-coupled device (CCD) camera (or a sensor) and transmitting the viewing state information to the server. For example, if the viewer displays his intention to subsequently view highlights of the currently viewed sporting event using a remote controller, the CCD camera operates so that viewing state information can be acquired and transmitted to the server.

If there is the viewer's request as described above, the TV may collect viewing state information about the number of actual viewers by tracking the viewers' eyes in operation S510. In other words, the TV may photograph an image while tracking the viewers' eyes.

In operation S520, while showing the sporting event, the TV transmits the viewing state information such as the viewers' facial expressions, voices, and motions to the server in real time.

In operation S530, the server collects and analyzes the data regarding the viewing states of the viewers which are received from the TV, thereby measuring level, i.e. importance of highlights according to a particular time, which are determined by the viewers. For example, by analyzing viewing states that there are a large number of viewers at a particular scene, the viewers' eyes concentrate on a particular scene, or the viewers' voices become louder, level of highlights may be set. During this process, the server may additionally analyze group-based information as described above. For example, gender or district may be determined using the viewers' intonation.

In operation S540, the server classifies and stores data regarding time-based highlights based on the determined level, and provides the data when the viewer requests. For example, if the viewer requests highlights of a particular program, the server may directly provide the TV with the requested highlights or may firstly provide list information and then provide data regarding highlights which the viewer selects from among the list information.

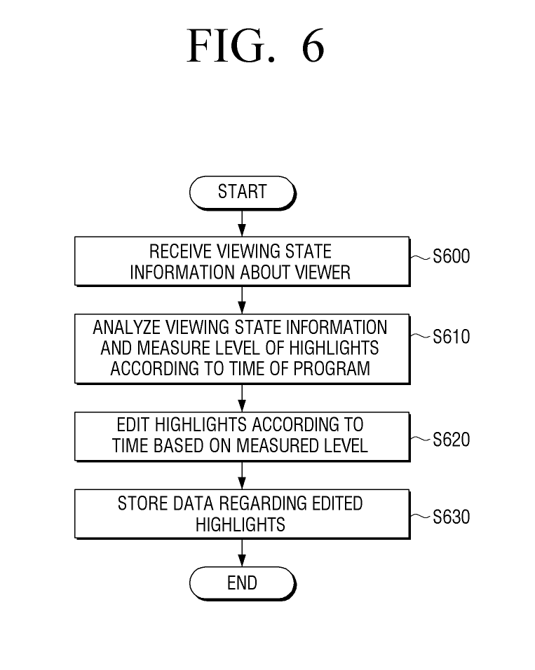

FIG. 6 is a flow chart illustrating a content providing method according to an exemplary embodiment.

With reference to FIGS. 1 and 6, in operation S600, the content providing apparatus 130 receives viewing state information about viewers who are watching a program from the image displaying apparatus 100. Since the viewing state information has been sufficiently described in the above, detailed description is not repeated here.

In operation S610, the content providing apparatus 130 analyzes the received viewing state information and thus measures the level of highlights according to the time of the program. For example, in order to set the level of highlights, after weight of 25% (or 2.5 level) is given to the number of viewers, weight of 25% is given to the viewers' facial expression, mouth movements, voice size, and spoken content, weight of 25% is given to the viewers' concentration level determined by tracking the viewers' eyes, and weight of 25% is given to the viewers' motion size and posture, each viewing state information being divided into 10 levels. The entire level may be determined by adding up and averaging all the levels of the viewing state information. In addition, when measuring the level, the content providing apparatus 130 may also acquire group information about the viewers by analyzing the viewing state information. Since the group information has been sufficiently described in the above, detailed description is not repeated here.

In operation S620, the content providing apparatus 130 edits data regarding highlights of the program according to viewers based on the level. For example, based on the viewers' voices, image data of several frame images corresponding to situations having the loudest voices are extracted and edited as highlights according to time.

In operation S630, the content providing apparatus 130 stores the edited data regarding the highlights according to level. When storing the data, the content providing apparatus 130 classifies and stores the data according to groups, programs, or levels of the same program. If there is a viewer's request, the content providing apparatus 130 provides the data.

For example, an analysis of a viewing state of a viewer in Seoul shows that the viewer is male in his 40s and from Gyeongsang-do. When the viewer requests highlights of a sporting event, the content providing apparatus 130 sorts highlights of a sports team of his native place, thereby providing the viewer with customized service.

Meanwhile, although all the components constituting the exemplary embodiments are combined or operate in one system, the inventive concept is not limited to the exemplary embodiments. That is, within the scope of the invention, all the components may be selectively combined and operated. In addition, each component may be implemented in independent hardware, or part or all of the components may be selectively combined and thus be implemented in a computer program having program modules which perform the combined functions in a single or a plurality of hardware. Codes and code segments constituting the computer program may be easily inferred by those skilled in the art. The computer program is stored in a computer-readable recording medium, and is read and executed by a computer, thereby implementing the exemplary embodiments. The recording medium of the computer program may include magnetic recording media, optical recording media, and carrier wave media.

The foregoing exemplary embodiments and advantages are merely exemplary and are not to be construed as limiting the present invention. The present teaching can be readily applied to other types of apparatuses. Also, the description of the exemplary embodiments is intended to be illustrative, and is not intended to limit the scope of the claims, and many alternatives, modifications, and variations will be apparent to those skilled in the art.

What is claimed is:

1. A first apparatus comprising:
a communication interface configured to receive viewer reaction information related to a program from a second apparatus; and
a highlight information generator configured to measure a level of viewer reaction by analyzing the received viewer reaction information, and generate highlight information by detecting highlights based on the measured level of viewer reaction,
wherein the generated highlight information is stored, and the second apparatus is provided with the stored highlight information.

2. The first apparatus as claimed in claim 1, wherein the highlight information generator generates list information related to the highlights according to the level of viewer reaction, and
wherein the first apparatus further comprises a storage, the storage providing the second apparatus with the highlight information of the highlights which the viewer selects from among the list information provided, when the viewer requests.

3. The first apparatus as claimed in claim 1, wherein the highlight information generator measures the level of viewer reaction by analyzing at least one from among a number of viewers who view the program, viewers' voices, viewer's facial expressions, and viewer's motions, using the viewer reaction information.

4. The first apparatus as claimed in claim 3, wherein the highlight information generator determines that the level of viewer reaction is higher when at least one from among the number of viewers is large, and the viewers' voices, facial expressions, or motions are large.

5. The first apparatus as claimed in claim 1, wherein the highlight information generator measures the level of viewer reaction according to a group related to at least one from among viewers' gender, district, age, and tendency, by analyzing the viewer reaction information, and detects the highlights based on the measured level of viewer reaction according to the group.

6. The first apparatus as claimed in claim 5, further comprising a storage, wherein the storage stores data regarding the highlights according to an analyzed group and updates the stored data.

7. The first apparatus as claimed in claim 1, further comprising a storage, wherein the storage stores image information related to the program, and
the highlight information generator generates the highlight information by using the stored image information and the viewer reaction information.

8. The first apparatus as claimed in claim 1, wherein the highlight information generator generates the highlight information by detecting highlights related to a level which is higher than a preset threshold value.

9. A content providing method comprising:
receiving viewer reaction information related to a program from an apparatus;
measuring level of viewer reaction by analyzing the received viewer reaction information;
generating highlight information by detecting highlights based on the measured level of viewer reaction; and
storing the generated highlight information, and providing the apparatus with the stored highlight information.

10. The content providing method as claimed in claim 9, further comprising:
generating list information related to the highlights according to the level, and
providing the list information when the viewer requests the highlights related to the program; and
providing the highlight information related to the highlights which the viewer selects from among the list information.

11. The content providing method as claimed in claim 9, wherein in the measuring of the level, the level is measured by analyzing at least one from among a number of viewers who view the program, viewers' voices, facial expressions, and motions, using the viewer reaction information.

12. The content providing method as claimed in claim 11, wherein in the measuring of the level, the level is set higher when the number of viewers is large or when the viewers' voices, facial expressions, or motions are large.

13. The content providing method as claimed in claim 9, wherein in the measuring of the level, the level is measured according to a group related to at least one from among viewers' gender, district, age, and tendency, by analyzing the viewer reaction information, and
in the generating of the highlight information, the highlight information related to the highlights are generated based on the measured level according to the group.

14. The content providing method as claimed in claim 13, wherein in the storing of the generated highlight information, the highlight information related to the highlights is stored according to an analyzed group and the stored information is updated.

15. The content providing method as claimed in claim 9, wherein in the storing of the generated highlight information, image information related to the program is stored, and
in the generating of the highlight information, the highlight information is generated using the stored image information and the viewer reaction information.

16. The content providing method as claimed in claim 9, wherein in the generating of the highlight information, the highlight information is generated by detecting highlights related to a level of viewer reaction which is higher than a preset threshold value.

17. A first apparatus comprising:
a display unit which displays an image related to a program;
a viewer reaction information acquirer configured to acquire viewer reaction information related to the program and provide a second apparatus with the viewer reaction information; and
a user information inputter configured to request highlight information related to highlights of the program, which is generated based on the viewer reaction information and image information related to the program,
wherein the display unit additionally displays the highlight information provided from the content providing apparatus.

18. The first apparatus as claimed in claim 17, wherein the viewer reaction information acquirer comprises:
a photographing unit which outputs an image obtained by photographing a viewer, as the viewer reaction information; and
a voice recognizer configured to acquire and output the viewer's voice as the viewer reaction information.

19. The first apparatus as claimed in claim 17, further comprising:
a graphical user interface (GUI) generator configured to generate list information about the highlights,
wherein the display unit displays the generated list information in an interface window form and displays the highlight information which is selected from among the list information.

20. A computer-readable recording medium which stores a program to execute a content providing method, the method comprising:
receiving viewer reaction information related to a program from an apparatus;
measuring level of viewer reaction by analyzing the received viewer reaction information;
generating highlight information by detecting highlights based on the measured level of viewer reaction; and
storing the generated highlight information, and providing the image displaying apparatus with the stored highlight information.

21. The first apparatus according to claim 1, further comprising a storage which stores the generated highlight information and provides the second apparatus with the stored highlight information.
